(19) United States
(12) Patent Application Publication
(10) Pub. No.: US 2001/0043173 A1
(43) Pub. Date: Nov. 22, 2001

(54) FIELD SEQUENTIAL GRAY IN ACTIVE MATRIX LED DISPLAY USING COMPLEMENTARY TRANSISTOR PIXEL CIRCUITS

(76) Inventor: RONALD ROY TROUTMAN, RIDGEFIELD, CT (US)

Correspondence Address: DANIEL P. MORRIS, IBM CORPORATION, INTELLECTUAL PROPERTY LAW DEPT., P.O. BOX 218, YORKTOWN HEIGHTS, NY, 10598

(21) Appl. No.: 08/923,795

(22) Filed: Sep. 4, 1997

(51) Int. Cl. G09G 3/32

(52) U.S. Cl. 345/82

(57) ABSTRACT

Disclosed is a pixel circuit consisting of complementary N- and P-channel MOS field-effect transistors (or of thin-film transistors), a capacitor, and an organic light-emitting diode. This circuit stores a voltage signal that is used to control the amount of light emitted from the pixel by means of a CMOS inverter. This pixel circuit is used in a two-dimensional array to form an active-matrix OLED display. The amount of light emitted at each pixel during a frame time is controlled by dividing the frame time into many sub-frames (or fields) and changing the stored voltage at the beginning of each sub-frame in such a way that the integrated time a voltage is stored during a frame time determines the total amount of light emitted.

### CROSS-REFERENCE TO RELATED APPLICATION

The teaching of U.S. application Ser. No. ______, filed on the same day herewith entitled, “FIELD SEQUENTIAL GRAY SCALE ACTIVE MATRIX OLED DISPLAYS USING COMPLEMENTARY TRANSISTOR PIXEL LATCHES” to R. R. Troutman is incorporated herein by reference.

### FIELD OF THE INVENTION

The invention relates to a pixel circuit that enables filed-sequential gray scale operation of an active matrix display using an organic light emitting diode and a complementary transistor circuit at each pixel.

### BACKGROUND

References (1,2,3) teach the layout and related fabrication steps for a passive matrix OLED display. However, in passive matrix operation a given pixel emits light only during a line time. In a VGA display, for example, this translates to an optical duty factor of only 1/480=0.21%. To compensate, the pixel must emit 480 times as much light as a pixel that emits constantly. The disadvantages of such operation are (a) higher voltage with attendant higher power, (b) operation at sub-optimum levels of electrical/optical conversion efficiency, (c) possible visual artifacts, and (d) faster degradation of the display. An active matrix OLED display would solve these problems.

Reference (4) teaches a pixel circuit designed for gray scale operation in an active matrix OLED display. This circuit stores the n bits of gray scale in n memory elements at each pixel. However, this circuit requires at least 6n+2 MOS transistors and n column lines per pixel. Such a circuit would be much too large for use in a practical display. What is needed is a much simpler circuit.

### REFERENCES CITED

1. U.S. Pat. No. 5,276,380—“Organic EL Image Display Device,” C. Tang, Jan. 4, 1994.

2. U.S. Pat. No. 5,294,869—“Organic EL Multicolor Image Display Device,” C. Tang and J. Littman, Mar. 15, 1994.

3. U.S. Pat. No. 5,294,870—“Organic EL Multicolor Image Display Device,” C. Tang, D. Williams, and J. Chang, Mar. 15, 1994.

4. U.S. Pat. No. 4,996,523—“EL Storage Display with Improved Intensity Driver Circuits,” C. S. Bell and M. J. Gaboury, Feb. 26, 1991.

5. C. W. Tang and S. A. VanSlyke, “Organic EL Diodes,” Appl. Phys. Lett. vol. 51, pp. 913-915 (Sep. 21, 1987).

6. C. W. Tang, S. A. Van Slyke, and C. H. Chen, “Electroluminescence of Doped Organic Thin Films,” J. Appl. Phys., vol. 65, pp. 3610-3616 (May 1, 1989).

7. S. Guha, R. A. Haight, J. M. Karasinski, and R. R. Troutman, “Transparent Cathode Structure for OLEDs,” patent application YO896-0361.

These references are incorporated herein by reference.

### SUMMARY

This disclosure teaches a simple pixel circuit for achieving active matrix operation in an OLED display. The circuit comprises an access transistor in combination with a CMOS inverter and enables an operating voltage to be used for the OLED that exceeds the maximum allowable transistor voltage. This disclosure also teaches how such a pixel circuit can be digitally driven to achieve field-sequential gray-scale operation of the display.

### BRIEF DESCRIPTION OF THE DRAWINGS

FIG. 1A is the preferred version of the pixel circuit. The access device 102 and the pull-down device 106 of the CMOS inverter are both N-channel MOSFETs or TFTs, the pull-up device 107 is a P-channel MOSFET or TFT, and the OLED 108 is in the common cathode configuration.

FIG. 1B is a two-dimensional array of the pixel circuit of FIG. 1A showing how the active matrix OLED display is formed.

FIG. 2 shows a simplified cross section when the pixel circuit is implemented on a silicon substrate. In this case the access device and inverter devices are MOSFETs.

FIG. 3 shows the relevant cross section when the pixel circuit is implemented on a glass substrate. In this case the access device and inverter devices are either amorphous or polycrystalline silicon TFTs.

FIG. 4 is an alternative version of the pixel circuit. The access device 402 and the pull-up device 407 of the CMOS inverter are both P-channel MOSFETs or TFTs, the pull-down device 406 is a N-channel MOSFET or TFT, and the OLED 408 is in the common cathode configuration.

FIG. 5 is a third version of the pixel circuit. The access device 502 and the pull-down device 506 of the CMOS inverter are both N-channel MOSFETs or TFTs, the pull-up device 507 is a P-channel MOSFET or TFT, and the OLED 508 is in the common anode configuration.

FIG. 6 is a fourth version of the pixel circuit. The access device 602 and the pull-up device 607 of the CMOS inverter are both P-channel MOSFETs or TFTs, the pull-down device 606 is a N-channel MOSFET or TFT, and the OLED 608 is in the common anode configuration.

### DETAILED DESCRIPTION

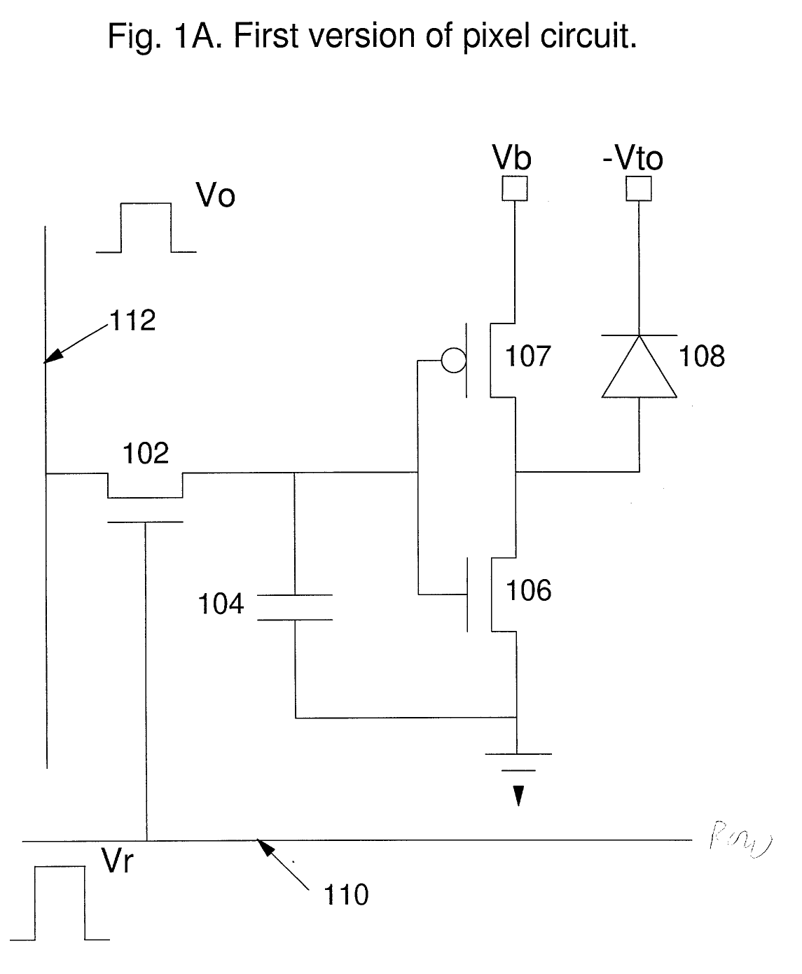

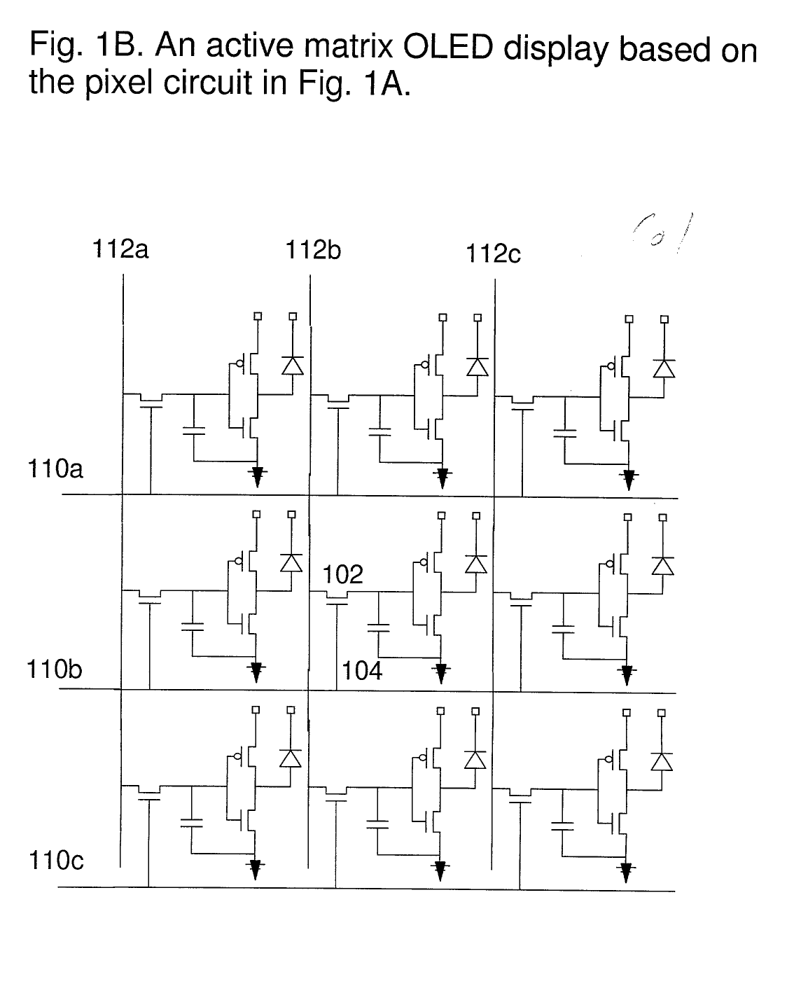

FIG. 1A shows the preferred version of the pixel circuit. This circuit comprises an access transistor 102, a CMOS inverter consisting of transistors 106 and 107, and an organic light-emitting diode (OLED) 108. In this particular embodiment, devices 102 and 106 are N-channel metal-oxide-semiconductor field-effect transistors (MOSFETs) or N-channel thin-film transistors (TFTs), device 107 is a P-channel MOSFET or TFT, and OLED 108 has a common cathode configuration. The access device 102 is used to transfer the voltage on column line 112 onto the capacitor 104 by applying a positive voltage V_{R} to row line 110. The column line voltage can be set to either ground or Vo when the gate line is selected, where Vₒ is the operating voltage for the CMOS technology used to fabricate the circuit. When the column line voltage is Vₒ, transistor 106 is turned on, transistor 107 is turned off, and the forward voltage bias on the OLED is Vₜₒ, the threshold voltage for the OLED, at and below which no light is emitted. Alternatively, when it is ground, transistor 106 is turned off, transistor 107 is turned on, and the OLED's forward bias is V_{b}+Vₜₒ. This latter condition produces the maximum amount of light emission from the OLED. The bias voltage −Vₜₒ is applied to the cathodes of all diodes in the display. The voltage V_{R} should be sufficiently larger than the sum of column line voltage Vₒ and the threshold voltage of transistor 102 to charge capacitor 104 in the required time.

The voltage V_{b} applied to the CMOS inverter formed by transistors 106 and 107 can be made equal to Vₒ or it can be made larger than Vₒ subject to the following two conditions:

(1) The voltage V_{b} cannot exceed the gate insulator breakdown voltage of transistors 106 and 107.

(2) The on-resistance of transistor 107 when (V_{b}−Vₒ)>|Vₜₚ|, where Vₜₚ is the threshold voltage of the P-channel transistor 107, must remain very much larger than the on-resistance of transistor 106 when its gate-to-source voltage equals Vₒ.

Usually the first restriction will be more stringent than the second, but this depends on the particular CMOS technology.

An active matrix display is created by building a two-dimensional array of pixels using the two transistor pixel circuit shown in FIG. 1A. The result is illustrated by the 3×3 array shown in FIG. 1B; extension to include any number of rows and columns should be obvious. A particular pixel is addressed by choosing the row line 110b and the column line 112b. When the row line is activated, transistor 102 is turned on, and the voltage on column line 112b is transferred to the capacitor 104. When the row line is de-activated, the voltage is held on capacitor 104 until the same row line is again activated. Usually the pixels along an entire row line 110b are written at one time by placing the appropriate voltage on all of the column lines in the array (112a, 112b,112c, etc.) during the time a row line voltage is high.

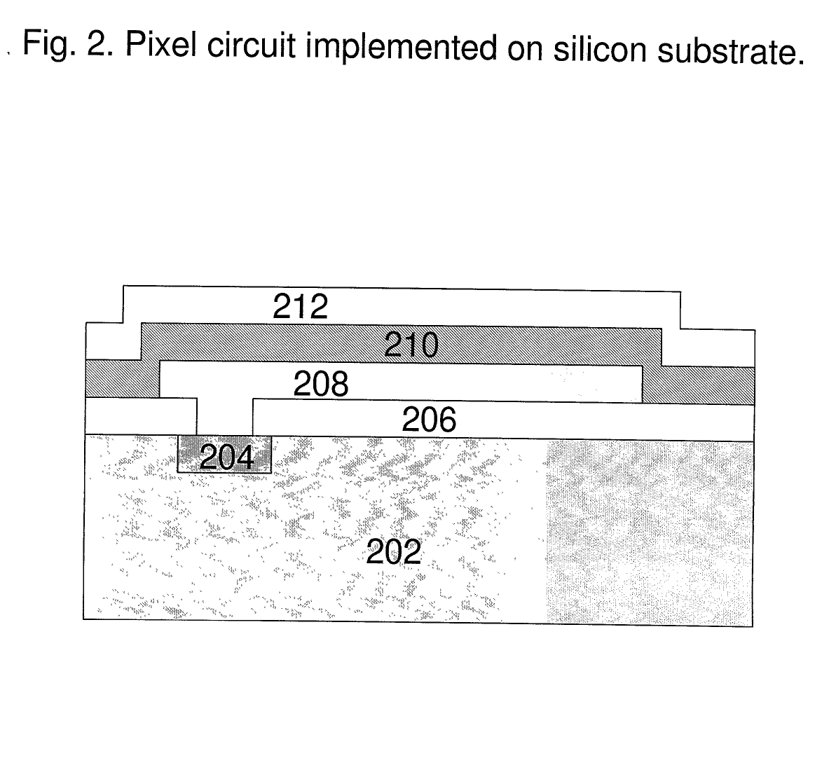

The pixel circuit of FIG. 1 can be implemented in many ways. In the preferred embodiment the transistors are MOSFETs fabricated according to well known techniques practiced in the integrated circuit (IC) industry. The relevant cross section is shown in FIG. 2. As part of such a silicon IC process the diffusion 204 is formed in a silicon substrate of the opposite type (202). An insulating film 206 is formed over the substrate and a contact hole is etched through the insulating film, permitting contact of the metal film 208 with the diffusion. This metal film is etched into patterns, forming one electrode of the OLEDs. Then the organic films 210 are thermally evaporated as discussed in references (5,6). Finally, transparent conductive film 212 (such as ITO) is deposited to form the common electrode. More detail on one type of embodiment can be found in reference (7).

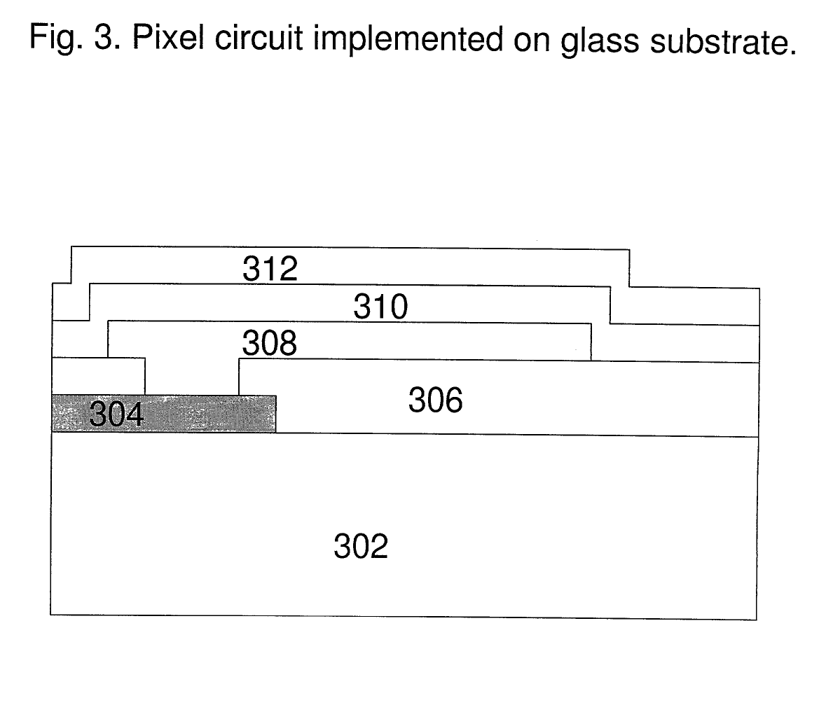

In another embodiment the access transistor and current control transistor are amorphous or polycrystalline thin-film transistors fabricated according to well known techniques practiced in the display industry for active matrix liquid-crystal displays. FIG. 3 shows a relevant cross section. As part of that process a highly conductive polycrystalline region 304 is formed on a glass substrate 302. Then an insulating layer 306 is formed and a contact hole etched, allowing the metal film 308 to contact region 304. Next the organic film layers 310 are thermally evaporated as discussed in references (5,6). Finally the transparent conductive film 312 is deposited to form the common electrode.

Gray-scale operation of the display is accomplished by dividing the frame time T_{f} into multiple sub-frames T_{sfk} and addressing all row lines during each sub-frame time. Each column line is either V_{H} or V_{L} during the line time, and this voltage is written into the storage capacitor 104 of all pixels along the activated row line. Common values are V_{L}=0 and V_{H}=V₀, as discussed above with reference to FIG. 1. When Vₒ is transferred to the capacitor 104, the forward bias on the OLED is Vₜₒ, and no light is emitted. When zero voltage is placed on the column line and transferred to the capacitor 104, the forward bias on the OLED is V_{b}+Vₜₒ, and the maximum amount of light is emitted. The maximum intensity of light is chosen by setting the bias voltage V_{b}, subject to the restrictions discussed above. As will be seen in subsequent discussions V_{H}=0 and V_{L}=−Vₒ in alternative versions.

For n bits of gray scale there are n sub-frames, and the sum of all sub-frame times equals the frame time T_{f}. A pixel's luminance is directly proportional to the fraction of frame time the pixel is turned on, and each of the sub-frame times is weighted to produce the 2ⁿ gray scale levels wherein n is an integer preferably from 1 to 8. Various weightings are possible and a binary weighting algorithm is discussed below.

For a display with M rows and N columns, each sub-frame requires M×N bits of data, and these can be stored in a buffer memory. For each row line access, N bits are read from the buffer memory and written to the N storage capacitors on the accessed row line, and this is continued until all row lines have been accessed. The time required to transfer all M×N bits is the write time T_{W}, and this time must be less than the sub-frame time for the least significant bit. Under this condition the maximum possible length of time a signal is stored in each pixel of the display is equal to a sub-frame time since each row of pixels is sequentially rewritten every subframe.

Several possibilities exist for presenting the n bits to a pixel. One possible ordering is to read the least significant bit first and to weight the first sub-frame time as T_{sf1}/T_{f}=1/(2ⁿ−1), followed by the second-least significant bit and weighting the second sub-frame time T_{sf2}/T_{f}=2/(2ⁿ−1), and so on until the most significant bit is reached, and its sub-frame weighting is T_{sfn}/T_{f}=2ⁿ⁻¹/(2ⁿ−1). With n=4, for example, the weightings are 1/15, 2/15, 4/15, and 8/15.

Another possible ordering is to present the most significant bit first, followed by the second-most significant bit, etc., until the least significant bit is reached. Still other orderings are possible, in which the bit ordering is chosen to avoid visual artifacts if they exist.

As an example of how data is written to the pixel capacitors, consider a display with n=4 bits of gray scale and a 60 Hz refresh rate. The frame time is then 16.67 ms, and the sub-frame time for the least significant bit is 16.67/15=1.11 ms. During a write time T_{W}<1.11 ms, the least significant gray scale bit is written into all pixels. At the end of 1.11 ms the second-least significant bit is written into all pixels, again requiring a time T_{W}. The sub-frame time for this bit 16.67(2/15)=2.22 ms, and after this time the third-least significant bit is written into all pixels. This data transfer from the buffer memory to the pixels continues until the end of the sub-frame for the most significant bit, at which time the least significant bit for the next frame is transferred.

If a separate buffer memory is used for each sub-frame, then n buffer memories are required. After the data from one buffer is transferred to the display, new data can be entered into that buffer as preparation for the next data transfer to the display, insuring continuous flow of data to the display without any dead time. This can also be accomplished by a single buffer memory having simultaneous read/write capability.

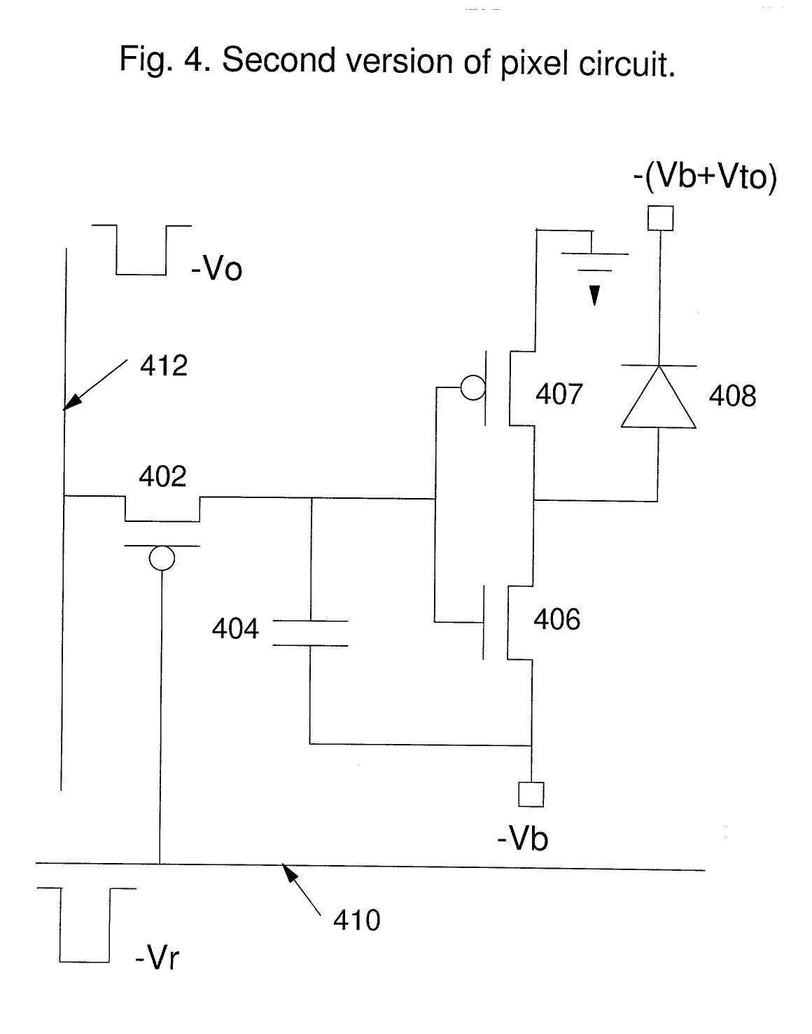

FIG. 1A shows a pixel circuit using an N-channel MOSFET or TFT for the access transistor and a common cathode OLED. Alternatively, a P-channel access transistor can be used with a common cathode OLED 408, as shown in FIG. 4. Now the row and column lines operate with negative polarity pulses, and the bias voltages −V_{b} and −(V_{b}+Vₜₒ) are also negative. The bias voltage V_{b} can be set equal to Vₒ or it can exceed Vₒ subject to the following two conditions:

(1) The voltage Vₒ cannot exceed the gate insulator breakdown voltage of transistors 406 and 407.

(2) The on-resistance of transistor 406 when (V_{b}−Vₒ)>Vₜₙ, where Vₜₙ is the threshold voltage of the N-channel transistor 406, must remain very much larger than the on-resistance of transistor 407 when its gate-to-source voltage equals −Vₒ.

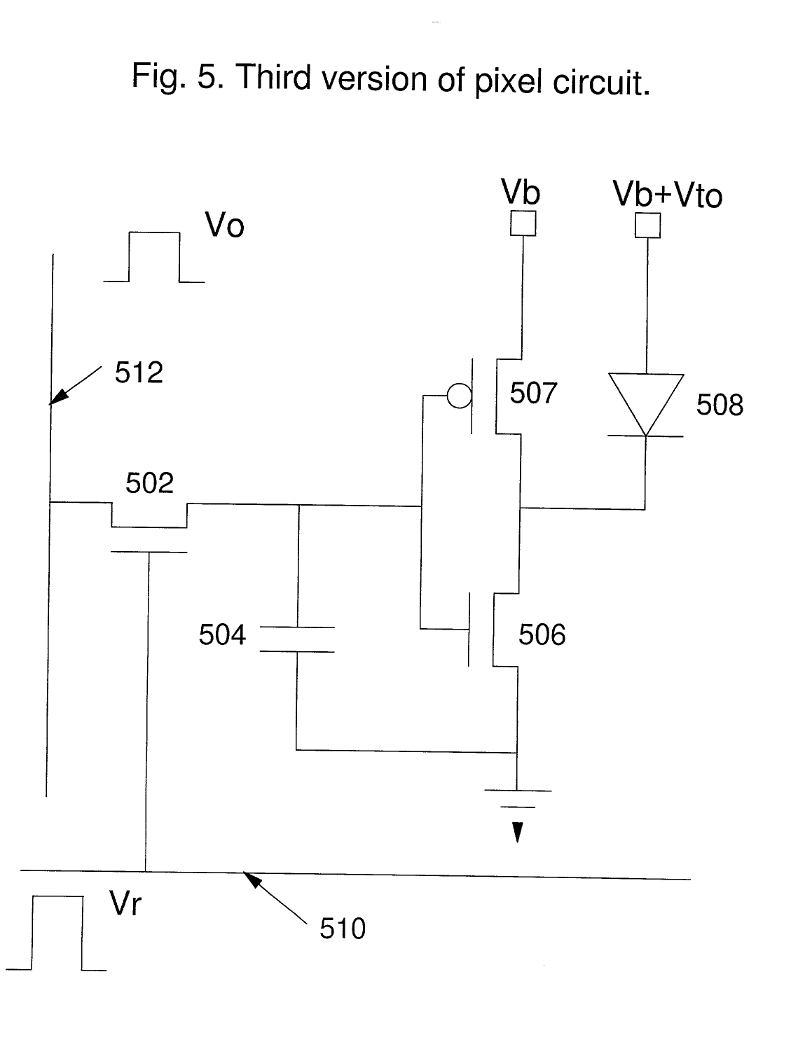

The preferred pixel circuit for an OLED in the common anode configuration is shown in FIG. 5. This version retains an N-channel MOSFET for the access transistor and a positive polarity for the row and column pulses. Now the roles of the V_{H} and V_{L} pulses are reversed compared to FIG. 1A, i.e., the OLED 508 emits light when V_{H}=Vₒ is stored on capacitor 504 and is dark when V_{L}=0 is stored on capacitor 504.

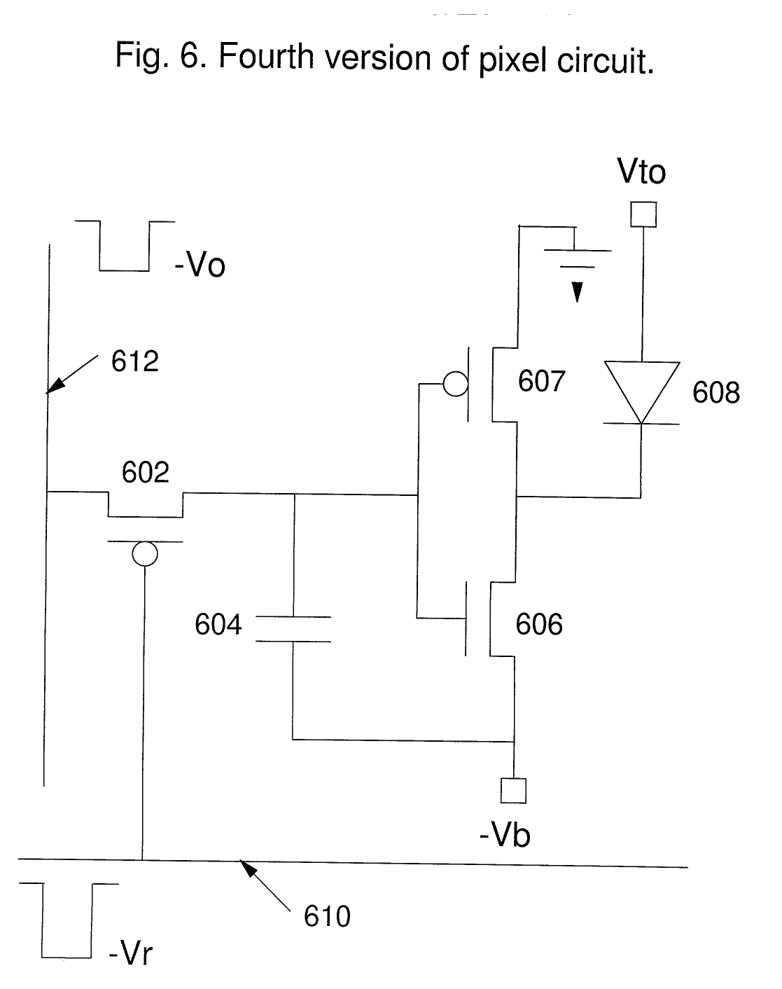

The fourth version, shown in FIG. 6, is the complementary circuit to that shown in FIG. 5. The row and column pulses are of negatively polarity, as is the bias voltage −V_{b}, and the access transistor is a P-channel MOSFET or TFT. The OLED 608 emits light when V_{H}=0 is stored on capacitor 604 and is dark when V_{L}=−Vₒ is stored on capacitor 604.

The above descriptions are given by way of example only and are not intended to limit the scope of the present invention in any way except as set forth in the following claims.

What is claimed is:

1. An active matrix light-emitting diode (LED) display comprising: a pixel circuit that stores a signal voltage by selectively addressing a row and a column line in the display and means for transferring the signal voltage from the column line to a capacitance by means of a transfer device, thereby regulating current through a CMOS inverter and a LED, to control the amount of light emitted from the LED.

2. An active matrix light-emitting diode display according to claim 1 in which the transfer device and CMOS inverter are MOSFETs fabricated in a silicon substrate;

3. An active matrix light-emitting diode display according to claim 1 in which the transfer device and CMOS inverter are polycrystalline silicon TFTs fabricated on a glass substrate;

4. An active matrix light-emitting diode display according to claim I in which the transfer device and CMOS inverter are amorphous silicon TFTs fabricated on a glass substrate;

5. An active matrix light-emitting diode display according to claim 1 in which the access device is an N-channel MOSFET, a CMOS inverter consisting of an N-channel MOSFET and a P-channel MOSFET controls the LED current, and the LED is in the common cathode configuration;

6. An active matrix light-emitting diode display according to claim 1 in which the access device is a P-channel MOSFET, a CMOS inverter consisting of an N-channel MOSFET and a P-channel MOSFET controls the LED current, and the LED is in the common cathode configuration;

7. An active matrix light-emitting diode display according to claim 1 in which the access device is an N-channel MOSFET, a CMOS inverter consisting of an N-channel MOSFET and a P-channel MOSFET controls the LED current, and the LED is in the common anode configuration;

8. An active matrix light-emitting diode display according to claim 1 in which the access device is a P-channel MOSFET, a CMOS inverter consisting of an N-channel MOSFET and a P-channel MOSFET controls the LED current, and the LED is in the common anode configuration;

9. An active matrix light-emitting diode display according to claim 5 or 6 in which the N-channel and P-channel MOSFETs are fabricated in single crystal silicon, and the LED is fabricated on top of the pixel circuit with its anode electrically connected to the output node of the CMOS inverter;

10. An active matrix light-emitting diode display according to claim 7 or 8 in which the N-channel and P-channel MOSFETs are fabricated in single crystal silicon, and the LED is fabricated on top of the pixel circuit with its cathode electrically connected to the output node of the CMOS inverter;

11. An active matrix light-emitting diode display according to claim 1 in which the access device is an N-channel TFT, a CMOS inverter comprising an N-channel and a P-channel TFT controls the LED current, and the LED is in the common cathode configuration;

12. An active matrix light-emitting diode display according to claim 1 in which the access device is a P-channel TFT, a CMOS inverter comprising an N-channel and a P-channel TFT controls the LED current, and the LED is in the common cathode configuration;

13. An active matrix light-emitting diode display according to claim 1 in which the access device is an N-channel TFT, a CMOS inverter comprising an N-channel and a P-channel TFT controls the LED current, and the LED is in the common anode configuration;

14. An active matrix light-emitting diode display according to claim 1 in which the access device is a P-channel TFT, a CMOS inverter comprising an N-channel and a P-channel TFT controls the LED current, and the LED is in the common anode configuration;

15. An active matrix light-emitting diode display according to claim 11 or 12 in which the N-channel and P-channel TFTs are fabricated using amorphous or polycrystalline silicon deposited on a glass substrate, and the LED is fabricated on top of the pixel circuit with its anode electrically connected to the output node of the CMOS inverter;

16. An active matrix light-emitting diode display according to claim 13 or 14 in which the N-channel and P-channel TFTs are fabricated using amorphous or polycrystalline silicon deposited on a glass substrate, and the LED is fabricated on top of the pixel circuit with its cathode electrically connected to the output node of the CMOS inverter;

17. An active matrix light-emitting diode display according to claim 1 in which the LED is turned on for only a portion of the frame time, this portion being adjusted to provide a desired gray level.

18. An active matrix light-emitting diode display according to claim 17 whereby the frame time is divided into sub-frames and each LED is turned on during some sub-frames and not others in such a way to achieve gray scale operation;

19. An active matrix light-emitting diode display according to claim 18 in which the duration of the sub-frames are chosen according to a binary weighting.

20. An active matrix light-emitting diode display according to claim 19 in which the binary weighting is done according to the formula T_{sfk}/T_{f}=2^{k-1}/(2ⁿ−1), where T_{sfk} is the time duration of sub-frame k, T_{f} is the frame time of the display, and n is the number of gray scale bits.

21. An active matrix light-emitting diode display according to claim 1 or 22 wherein said LED is an organic light-emitting diode.

22. A structure comprising a circuit comprising a light emitting diode having a first terminal and a second terminal an access transistor having a first terminal, a second terminal and a gate electrode; an inverter comprising a first inverter transistor and a second inverter transistor each of which has a first terminal, a second terminal and a gate electrode; said first and second inverter transistors being of opposite conductivity types;
a capacitor having a first terminal and a second terminal;
said gate electrode of said first inverter transistor being electrically connected to said gate electrode of said second inverter transistor, to said first terminal of said access transistor and to said first terminal of said capacitor;
said first terminal of said light-emitting diode being electrically connected to said first terminal of said first inverter transistor and to said second terminal of said second inverter transistor.

23. A structure according to claim 22 wherein said light-emitting diode is an organic light-emitting diode.
